(19) United States
(12) Patent Application Publication
(10) Pub. No.: US 2018/0001319 A1
(43) Pub. Date: Jan. 4, 2018

(54) ANALYSIS DEVICE, ANALYSIS APPARATUS FOR IDENTIFICATION OF ANALYTES IN FLUIDS AND USE OF THE ANALYSIS DEVICE

(71) Applicant: Medcom Advance, S.A., Barcelona (ES)

(72) Inventors: Juan SAGALES MAÑAS, Barcelona (ES); Edgar GUERRERO GONZALEZ, Barcelona (ES)

(21) Appl. No.: 15/536,719

(22) PCT Filed: Dec. 16, 2014
(86) PCT No.: PCT/EP2014/077932

§ 371 Date: Jun. 16, 2017

(51) Int. Cl. B01L 3/00; G01N 21/65

(52) U.S. Cl. CPC B01L 3/502715; G01N 21/658; B01L 2300/0867; B01L 2400/0406

(57) ABSTRACT

An analysis device and an analysis apparatus for identification of analytes in fluids applying the SERS effect which provides a safe way to perform analysis, avoiding an accidental cross-contamination without the use of disinfectant products; the analysis device comprising a casing enclosing a sample region for receiving a fluid sample, and a nanoparticle region for storing at least a nanoparticle fluid; the sample region and the nanoparticle region being in fluid communication each other through a passage; driving means in fluid communication with the passage; a mixing region in fluid communication with the passage; and the casing being adapted to allow an incident monochromatic light from an external source to strike on the mixing region, and a reflected light from the mixing region to leave the casing.

### OBJECT OF THE INVENTION

The present invention is related to an analysis device, an analysis apparatus and the use of the analysis device for identification of analytes in fluids applying the SERS effect that incorporates considerable innovations and advantages.

More specifically, the invention refers to an analysis device, an analysis apparatus for identification of analytes in fluids and the use of the analysis device, which provides a safe way to perform analysis, avoiding an accidental cross-contamination without the use of disinfectant products, detergents or any kind of procedure to eliminate substances potentially present in the devices where the sample fluid is to be placed or manipulated.

The object of the invention also provides a relatively fast, easy and comfortable way for detecting any kind of analyte in samples of fluids.

### BACKGROUND TO THE INVENTION

In the recent years systems, methods and devices able to detect low levels of microorganisms, including pathogens, o any kind of analytes from fluid samples (e.g., water, air, blood, stool, urine, etc.) have gained significant importance.

One of the most promising solutions related to the above matter involves the use of encoded nanoparticles. Encoded nanoparticles are between the most powerful alternatives for high-throughput multiplex screening^{[1]} in microarray technology^{[2]}, diagnosis^{[3]} and bioimaging^{[4]}. These materials are simple and cost-effective platforms which allow for fast, sensitive and reliable analysis^{[1b,5]}. During the last decade, several encoded particles were prepared^{[6]} using codification strategies based on changes in particle shape,^{[7]} composition,^{[8]} physical marks^{[6c]} or spectroscopic properties (e.g. luminescence or vibrational fingerprints).^{[4, 9]} Among all of them, those based on surface-enhanced Raman scattering (SERS) are gaining importance^{[10]} due to: i) the virtually unlimited multiplexing capability associated with the unique vibrational fingerprint of the different codes, ii) short detection times (milliseconds) thanks to the intrinsic sensitivity of the SERS phenomena;^{[11]} iii) small size, allowing for bioimaging;^{[12]} and, iv) photostability and low toxicity (as compared with those of dyes or quantum dots).^{[13]}

The use of technology based on SERS-encoded nanoparticles (also indicated as SERS-tags) for identification of microorganisms and generally analytes is a well-known solution. WO2013165615 discloses methods, systems, and devices for detecting and/or identifying one or more specific microorganisms in a culture sample. This culture sample is formed by indicator particles (SERS-active nanoparticles) and microorganisms of interest. Then agitating magnetic capture particles can be used to capture the microorganism-indicator particle complex and concentrate the complex in a localized area of an assay vessel for subsequent detection and identification. This invention needs for a culture sample and magnetic capture particles to capture the microorganism-indicator particle complex, which means a relatively long duration for the preparations and an overall complexity due to the adding of magnetic particles.

It is also known in the art contacting SERS-encoded nanoparticles with a fluid sample by means of a device, allowing a relatively rapid identification of microorganisms and other targets analytes. The state-of-art device is equipped with a lasser emitted for subjecting the mixture of nanoparticles and microorganisms to surface enhanced Raman spectroscopy (SERS); this mixture is realized inside the device by entering the sample fluid and the fluid with the encoded nanoparticles through different inlets. Both inlets meet at a point and the produced mixture is carried until a point where the lasser is applied. However, this device shows three main drawbacks:

Firstly, the encoded nanoparticles have to be selected and then introduced into the corresponding inlet of the device, and then the fluid sample is also introduced through the appropriate duct. As can be supposed, the operation takes a length of time shorter than the described one in WO2013165615 since, inter alia, no culture sample is prepared, but it also takes time to select and introduce the encoded nanoparticles and the procedure can be implemented erroneously due to a human error.

Secondly, the ducts and also all the parts in contact with the fluids have to be duly cleaned before every analysis with special systems or products in order to avoid any cross-contamination. The cross-contamination invalidates any result from the analysis, and obliges to use products and systems which can be dangerous for the health of the user, besides the higher cost.

Thirdly, the portability of the system is relatively reduced, since the bulky device is placed in a lab and it is not conceived to be carried outside the lab.

Therefore, there is still a need for an improved system for identification of analytes in fluids reducing the complexity, length of time, the risk of human error and the use of cleaning systems and products.

### DESCRIPTION OF THE INVENTION

The present invention has been developed for the purpose of providing an analysis device, an analysis apparatus and the use of such analysis device that solves the above-mentioned disadvantages, in addition contributing other additional advantages that will become clear from the description that is given below.

In the present document, the term “analyte” shall be understood as any biological entity to be detected and in the broadest sense this term refers to any substance with the capacity to bind to a ligand of the encoded and/or biofunctionalized nanoparticles. By way of non-limiting illustration, the term “analyte” includes cells, microorganisms, viruses, nucleic acids, peptide nucleic acids, antigens, peptides and proteins.

In the sense used in this document, the term “microorganism” includes very small or microscopic organisms which can be unicellular or multicellular organisms. The concept of “microorganism” lacks any taxonomic or phylogenetic implication since it encompasses unicellular organisms not related to one another.

The term “fluid” will be understood in the present specification as any kind of substance that is capable of flowing, as a liquid or a gas.

The term “microchannel” will be understood in the present specification to a channel with a width comprised in the range of 500 nm to 10 mm.

It is therefore, an object of the invention to provide an analysis device for identification of analytes in fluids comprising:
a casing enclosing at least partially a sample region for receiving a fluid sample, and a nanoparticle region for storing at least a nanoparticle fluid;
the sample region and the nanoparticle region being in fluid communication each other through at least a passage;
driving means in fluid communication with the passage;
a mixing region in fluid communication with the passage, the mixing region being configured to receive a combination defined by a mixture of the fluid sample and the nanoparticle fluid; and
the casing being adapted to allow at least an incident monochromatic light from an external source to strike on the mixing region so that the combination is excitable, and at least a reflected light from the mixing region to leave the casing.

Due to these characteristics, an analysis device is achieved that avoids the risk of human error when selecting the encoded particles which are needed and during handling of the nanoparticles. Another risk of human error which is eliminated is related to the cleaning of the analysis device since a new and non-used analysis device is used in every identification of analytes. The user chooses the appropriate analysis device which can be equipped with the correct encoded nanoparticles; it is envisage that the analysis device can be filled with several encoded nanoparticles and/or biofunctionalized ones.

Another advantage of this object is that the analyte is not only identified but also quantified. All the combination is struck on with the incident monochromatic light, providing the exact quantity of analyte in the sample fluid.

Unlike the bulky device of the previous art the present analysis device is relatively light and compact, which helps to carry it outside a lab and take the fluid sample directly from the source with the analyte or analytes.

It is therefore achieved an improved analysis device for identification of analytes in fluids reducing the complexity, length of time, the risk of human error and the use of cleaning systems and products. These advantages can be applied in several sensitive fields like health-care, food industries, air conditioning facilities, water supply, agriculture, security, etc.

In a preferred form, the sample region and the nanoparticle region can comprise respectively at least a sample container and a nanoparticle container; the fluid sample can comprise at least one target analyte, and the nanoparticle fluid can comprise a plurality of SERS-encoded nanoparticles.

The analysis device can comprise a membrane in fluid communication with the sample region such that the sample region can be fed from outside the casing, for example with a syringe.

According to another aspect of the invention, the driving means can be of passive type or active type. In the first case, the driving means of the passive type comprises the passage configured to allow capillary motion. In the second case, the driving means of the active type comprises a pump. When the analysis device is provided with active driving means the casing can be also provided with at least one connecting element for electrically feeding the driving means and/or transmitting data. In both cases, the combination defined by the mixture of sample fluid and the nanoparticle fluid is obtained in predictable and repetitive conditions.

In one embodiment of the invention, the casing comprises a first light permeable portion to allow the incident monochromatic light to strike on the mixing region and a second light permeable portion to allow the reflected light to leave the casing. Such incident monochromatic light is preferably a lasser beam.

In addition, the analysis device has a capsule-shape configuration for allowing a user-friendly device, improving the portability of the device.

Another object of the invention is providing an analysis apparatus for identification of analytes in fluids comprising:
a receiving region for receiving an analysis device as previously described;
an emitter adapted to produce an incident monochromatic light to strike on the mixing region;
reading means configured to receive the reflected light from the mixing region and to reading a SERS signal or an increase in said signal; and
control means in data communication with the emitter and the reading means.

These features allow obtaining an analysis apparatus which eliminates the need for cleaning the parts in contact with fluids, because all the fluids are kept inside the analysis device. The receiving region is specifically designed for receiving the analysis device, avoiding any mistake when fitting the analysis device. This relationship between the analysis device and the analysis apparatus provides a safe, rapid and reliable identification and quantification of analytes.

In one embodiment of the invention, the receiving region comprises fixing means matching at least partially the casing. This avoids the analysis device to be erroneously placed in the receiving region.

In a preferred form, the emitter is a lasser emitter and the analysis apparatus comprises additionally a connecting port able to be associated with at least one connecting element.

It is also another object of the invention provide the use of an analysis device as above described for the identification of analytes in fluids applying the SERS effect with the advantages mentioned above.

Other characteristics and advantages of the solar thermal collector object of this invention will become clear from the description of preferred, but not exclusive, embodiments, the drawings that are attached are by way of illustration but without being in any way limiting.

### BRIEF DESCRIPTION OF THE DRAWINGS

FIG. 1 is a perspective elevation view of an embodiment of a analysis device according to the invention;

FIG. 2 is a bottom plan view of the analysis device of the FIG. 1;

FIG. 3 is a longitudinal section view of the analysis device of the FIG. 2 along line A-A′;

FIG. 4 is a cross section view of the analysis device of the FIG. 2 along line B-B′;

FIG. 5 is an exploded view of the analysis device of the FIG. 1; and

FIG. 6 is a diagrammatical view of an analysis apparatus according to the invention with the analysis device of the FIG. 1.

### DESCRIPTION OF A PREFERRED EMBODIMENT

The attached figures show preferred and non-limiting embodiments respectively of an analysis device designated in a general way with reference number 100 and an analysis apparatus designated in a general way with reference number 200, objects of the present invention. Not visible parts are drawn by dotted lines in the attached figures.

The present preferred embodiment is based on SERS-encoded nanoparticle technology, regardless of the method, procedure or system followed and used to obtain the SERS-encoded nanoparticles.

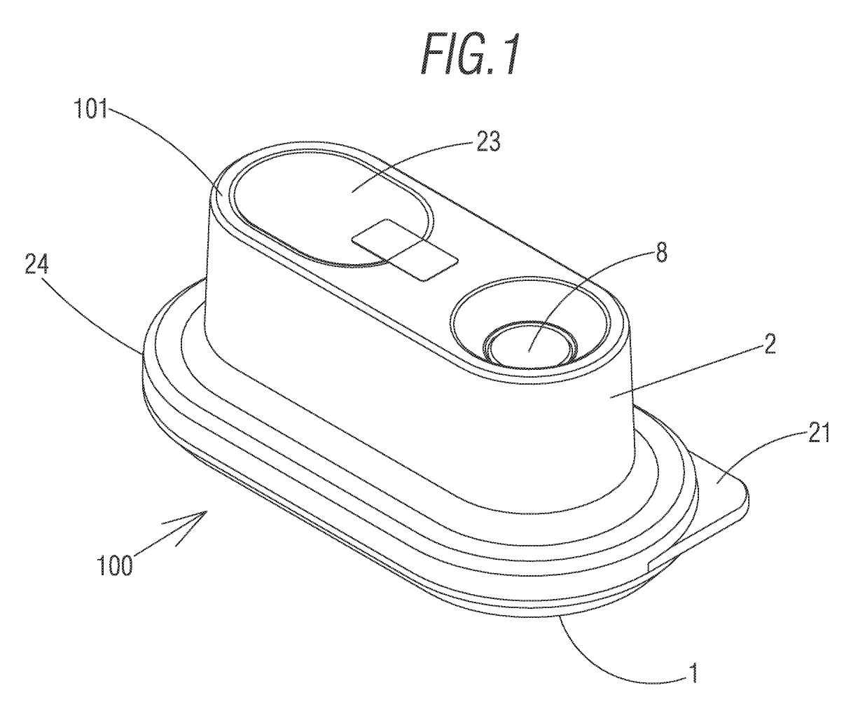

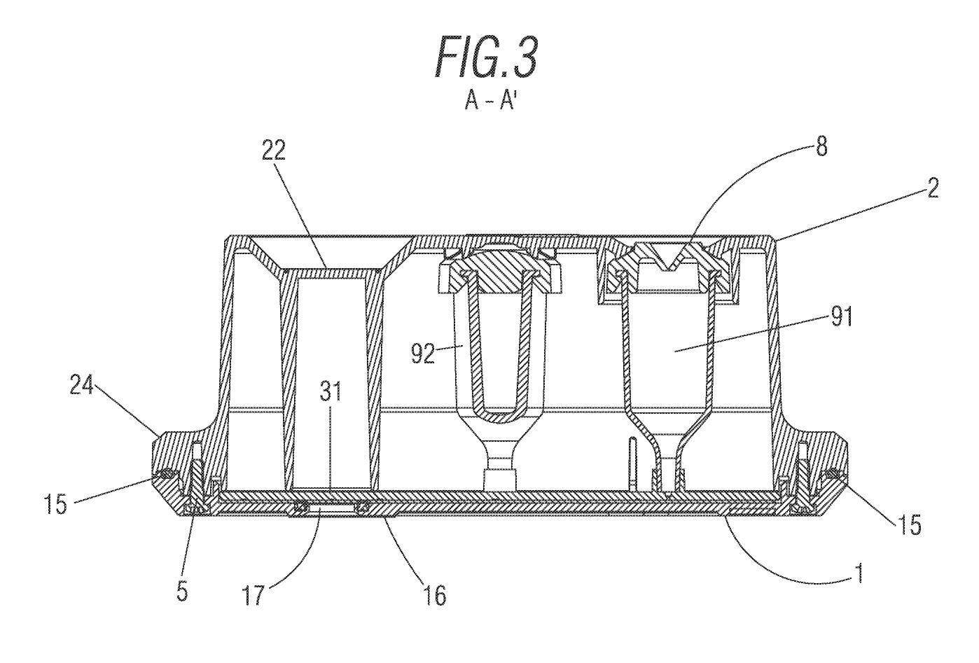

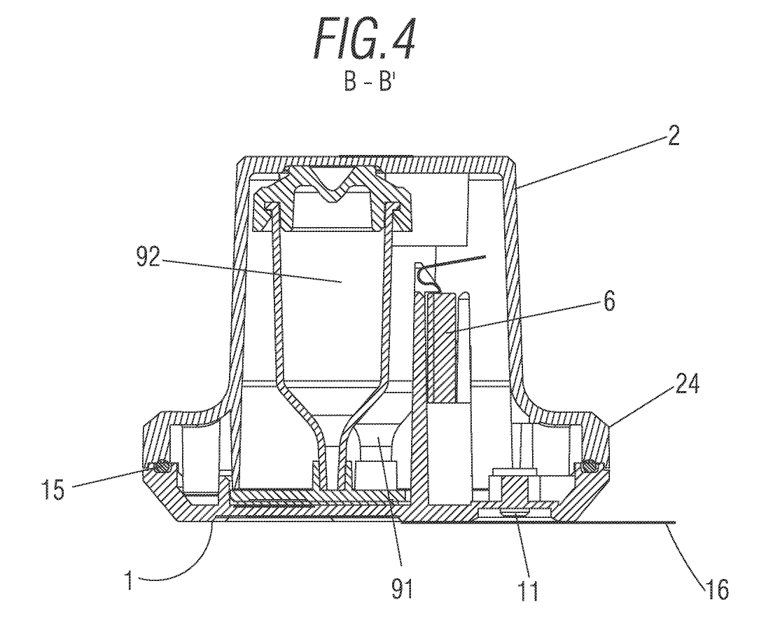

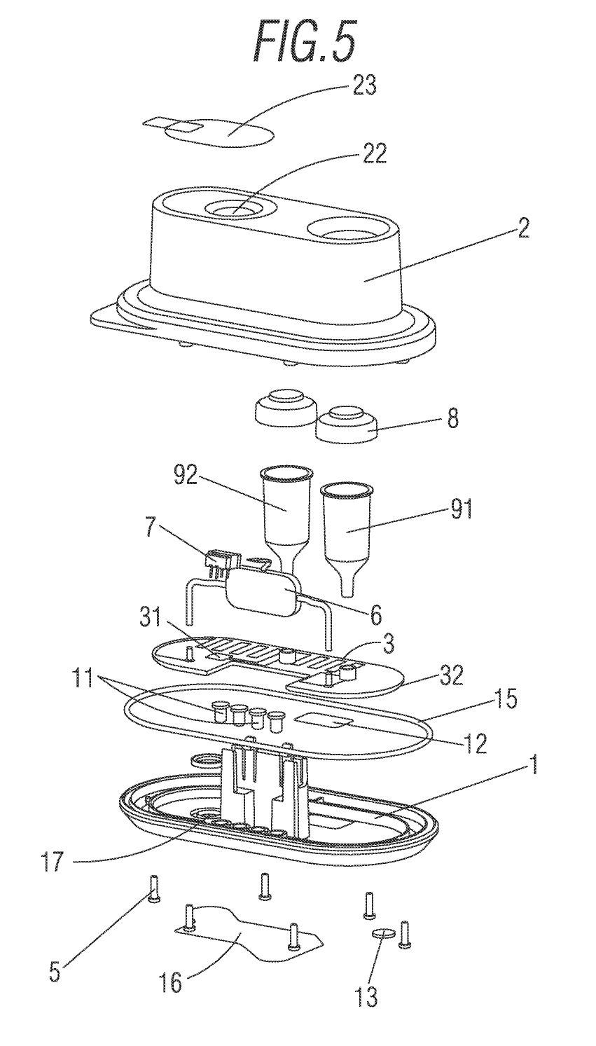

A preferred embodiment of an analysis device 100 for identification of analytes in fluids according to the invention can be seen in FIGS. 1-5, wherein it is shown that the analysis device 100 comprises a casing 101 enclosing at least partially a sample region for receiving a fluid sample, and a nanoparticle region for storing at least a nanoparticle fluid.

The fluid sample can encompass at least one target analyte (not shown) and the nanoparticle fluid can encompass a plurality of encoded nanoparticles (not shown).

Preferably the sample region comprises a sample container 91 and the nanoparticle region comprises a nanoparticle container 92. The number and the arrangement of the sample container 91 and nanoparticle container 92 can be obviously amended depending on the needs and the material used to produce them can be chosen from any available in market and appropriate for their function.

The sample region and the nanoparticle region, i.e. the sample container 91 and the nanoparticle container 92 in the present embodiment, are in fluid communication each other through at least a passage 3. This passage 3 is preferably a microchannel network provided onto a tray 32 with the nanoparticle container 92 and the sample container 91. A mixing region 31 is placed in fluid communication with the passage 3, the mixing region 31 being configured to receive a combination defined by a mixture of the fluid sample and the nanoparticle fluid. The mixing region 31 will be preferably a portion of the passage 3 and the tray 32 or at least the area beneath the mixing region 31 will allow the monochromatic light to pass through it.

The casing 101 is adapted to allow an incident monochromatic light, that in the present embodiment is a lasser beam, from an external source to strike on the mixing region 31 so that the combination can be excited, and at least a reflected light from the mixing region 31 to leave the casing 101. The characteristics of the lasser beam will be such for carrying on the surface-enhanced Raman scattering along with the encoded nanoparticles.

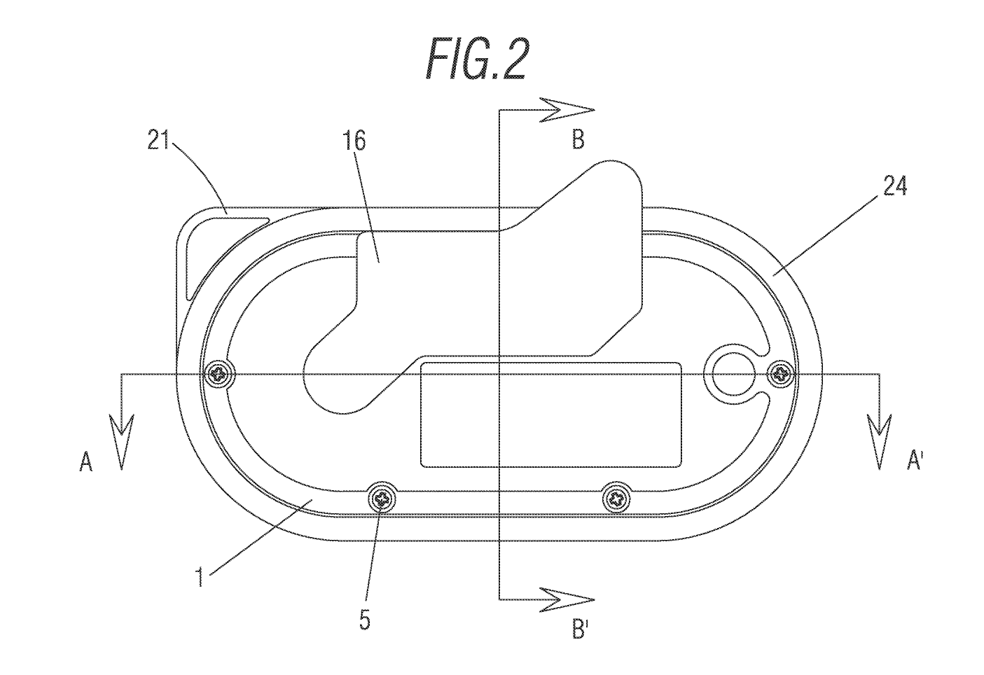

The casing 101 can comprise a first light permeable portion 17 to allow the incident monochromatic light to strike on the mixing region 31 and a second light permeable portion 22 to allow the reflected light to leave the casing 101. The first light permeable portion 17 and the second light permeable portion 22 are preferably transparent members for lasser beam. These transparent members are protected for instance with adhesive films 16, 23 in order to protect them before use as shown in FIGS. 1 and 2. The first light permeable portion 17 and the second light permeable portion 22 can be the same permeable portion if the reflected light from the mixing region 31 is so directed.

As mentioned, the incident monochromatic light is provided from an external source which will be describe later.

The analysis device 100 also comprises driving means in fluid communication with the passage 3. This driving means can be of passive type or active type. The driving means of the present embodiment is of the active type and comprises a pump 6, for instance from Bartels Mikrotechnik® or any other manufacturer of peristaltic o piston pumps, electrically fed from an outer power source with at least one contacting element 11 provided in the casing 101. A connecting element 7, such as Molex®, can be positioned between the contacting element 11 and the pump 6 and all three parts will be linked by means for instance of wires (not shown). In the illustrated embodiment the analysis device 100 is provided with four contacting elements 11 but that amount can be modified according to the needs. The contacting element 11 can be made for instance from any power conductive and also data-transmission enabling material. Through the contacting element 11 data can also be transmitted to the pump 6 or any other part for controlling operating parameters, as the flow sense along the passage 3, flow rate, pressure, etc. of the combination.

Other embodiments can be thought wherein data and power transmission are achieved wirelessly (not shown).

Alternatively, the driving means can be of the passive type and can comprises the passage 3 configured to allow capillary motion. The way to get capillary motion is well known for those skilled in the art (for example a microchannel network with a suitable diameter) so no further details will be exposed.

In the attached drawings the analysis device 100 comprises a membrane 8 in fluid communication with the sample region, i. e. sample container 91, such that the sample region can be fed from outside the casing 101. This embodiment is conceived for using for instance a syringe with the fluid sample and the membrane 8 may be manufactured for instance with any elastomeric material. However, in alternatives embodiments not shown specific members for directly introducing the fluid to be analysed into the sample region can be easily envisaged for those skilled in the art.

In the present invention the casing 101 encloses fully all the above mentioned parts in such a way that the analysis device 100 has preferably a capsule-shape configuration; for instance the casing can be embodied with an oval and elongated plant but any other design can be envisaged to provide the analysis device 100 as a capsule or box. The present embodiment of the casing 101 comprises two parts: a bottom portion 1 and top portion 2 in an operating sense, with an O-ring 15 placed therebetween for obtaining a sealed casing 101 in the form of a capsule. Both the bottom portion 1 and the top portion 2 can be joined by means of screws 5 or any other kind of joining elements such as dovetail joint or tongue and groove (not illustrated). The top portion 2 of the casing 101 also has a protrusion 21 extending solidly from the rest of the top portion 2 to help the user when handling the analysis device 100. The bottom portion 1 and the top portion 2 can be manufactured from an appropriate material such as any kind of polymer.

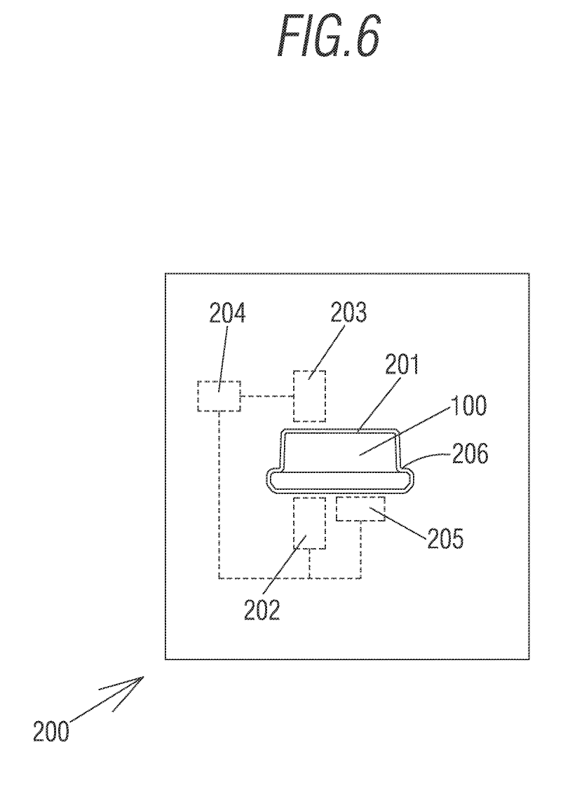

In FIG. 6, it is illustrated a non-limiting preferred embodiment of an analysis apparatus 200 for identification of analytes in fluids according to the invention. Such analysis apparatus 200 comprises a receiving region 201 for receiving an analysis device 100 as above described. The receiving region 201 can be preferably a cavity-like shape for enclosing the casing 101, as shown in the FIG. 6 or alternatively can take any other form, for instance a surface on the analysis apparatus 200 provided with a recess in a surface matching the casing 101 and where the analysis device 100 can rest (not shown).

For avoiding a wrong positioning and attachment of the analysis device 100 into the receiving region 201, the receiving region 201 can comprise fixing means 206 matching at least partially the casing 101. Fixing means 206 may be a specific shape of the receiving region 201 as depicted in figures or can be alternatively guides, locks, lids etc.

The analysis apparatus 200 comprises an emitter 202 adapted to produce the incident monochromatic light to strike on the mixing region 31. The emitter is preferably a lasser emitter since it will produce a lasser beam as above mentioned.

Additionally the analysis apparatus 200 comprises reading means 203 such as a light receiver configured to receive the reflected light from the mixing region 31 and to reading a SERS signal or an increase in said signal.

Control means 204, as for instance a processor, are also provided in data communication with the emitter 202 and the reading means 203.

Further to the emitter 202, the reading means 203 and the control means 204 will be of any type available to the skilled person and suitable for their function. The emitter 202 has to be able to produce for instance a lasser beam with the necessary features for implementing the surface-enhanced Raman scattering.

The analysis apparatus 200 further comprises a connecting port 205 able to be associated with the contacting element 11, for instance in direct contact o even spaced apart. The skilled person will be able to use any known principle to establish the communication without physical contact between the connecting port 205 and the contacting element 11.

A preferred embodiment of the analysis device 100 can be equipped with a RFID tag 12 or any other tag or means that allows the identification of the analysis device 100. This avoids the use of a wrong selected analysis device 100 with its specific encoded nanoparticles and can provide the analysis apparatus 200 with useful information about the analysis device 100 related to the encoded nanoparticles, manufacturing, advices, etc.

The user will choose the analysis device 100 according to the target analyte or analytes. As above mentioned this analysis device 100 has preferably a capsule-shape configuration with a casing 101 enclosing all the rest of the parts involved. The casing may be provided additionally with any labelling means for visually identifying the correct analysis device 100 before use such as labels, marks, etc not illustrated. However, this identification may be done due to the RFID tag 12. Then the user may introduce the fluid sample into the sample container 91 in the lab facility or may bring the analysis device 100 to the fluid source to be analysed since the features of the present analysis device 100 allows this advantage. The analysis device 100 can be placed for instance in ventilation or air conditioning ducts, water sources, fluid food systems, weather stations, etc. introducing the fluid to be analysed into the properly adapted sample region with ducts or membranes. The analysis device 100 may be located at the sample fluid source for a suitable period.

Once the sample container 91 is provided with the fluid sample containing the target analyte, the analysis device 100 may be placed in the receiving region 201 free of the adhesive films 16, 23. As above depicted the analysis apparatus 200 can comprise fixing means 206 matching at least partially the casing 101. In the attached figures can be seen that the casing 101 may have a rim 24 provided at least partially around the perimeter of the casing 101 seen in a plan view. The receiving portion 201 may have a configuration matching that profile of the casing 101, avoiding a wrong placement and any accidentally fall.

Then the control means 204 may detect the analysis device 100 due to the RFID tag 12 or a disc-shaped metal piece 13 and start the identification process owing to any detecting or proximity sensor in the analysis apparatus 200 capable of do it. This analyte identification process may be done automatically following a predefined sequence stored in the analysis apparatus 200 or following instructions from the user through an interface (not shown).

The control means 204 through the connecting port 205 and the contacting elements 11 send data instructions and power feeding to the pump 6 for getting the combination of fluid sample and nanoparticle fluid along the passage 3. The arrangement of the passage 3, in the form of microchannel, can be adapted and modified according to the requirements for providing the mixing region 31 with the duly combination. The control means 204 may actuate the emitter 202, producing a lasser beam (not shown) striking on the mixing region 31 and then the reading means 203 configured to receive the reflected light from the mixing region 31 can provide the control means 204 with data of the analysis. With this information the control means 204 can determine if the target analyte is found in the analysed fluid. The control means 204 also can quantify the amount of analyte in the fluid sample since due to the configuration of the analysis device 100 the fluid sample is brought in contact with the nanoparticle fluid which is encoded for binding a particular target analyte or analytes. The combination can be achieved in few minutes or even seconds and shows the overall quantity of analyte present in the fluid sample. All this procedure takes place until the acquisition of the corresponding spectrum Raman and processing by the control means 204.

The above describe procedure may follow a sequence of instructions of a computer program implemented with the control means 204 or alternatively with a computer (not shown) in data communication with the analysis apparatus 200. To this end, control means 204 may store the source code in order to automate the procedure or may be stored in any computer-readable medium in data communication with the control means 204 for executing the computer program. The sequence of instructions may be obviously adapted to particular conditions of analysis.

If the analysis device 100 comprises passive driving means, the combination can be obtained by capillarity motion in a set length of time, taking into account the features of the passage 3 as length, diameter, etc.

The present analysis device 100 may be disposable after one use or may be utilised several times before throwing it out depending on the analysis requirements: for instance infectious illnesses, pollutants, etc. would require only one use.

It can be appreciated that a report from the identification can be rapidly available in few seconds or minutes. The target analyte can be duly identified and quantified in a reliable manner, providing health-care staff, technicians, etc. with extremely valuable information. The present invention does not require any culture sample therefore saving time, avoiding the risk of human error and reducing costs.

The present analysis device 100 and analysis apparatus 200 do not require any disinfectant procedure, process, product for cleaning and/or hygienizing the parts involved in the analysis. This feature eliminates the risk of cross-contamination which is always when analysing samples.

The present analysis device 100 and analysis apparatus 200 also assure that the fluid containing the encoded nanoparticles meets the conditions for carrying out the identification in the most efficient way, since it has been selected and prepared accordingly.

The details, shapes, sizes and other accessorial elements, likewise the materials used in the manufacture of the analysis device 100 and the analysis apparatus 200 of the invention can be appropriately substituted by others that are technically equivalent and do not depart from the scope defined by the claims that are included below.

### REFERENCES

[1] a) A. Doerr, Nat Meth 2007, 4, 381; b) H. Fenniri, R. Alvarez-Puebla, Nat. Chem. Biol. 2007, 3, 247.
[2] R. Wilson, A. R. Cossins, D. G. Spiller, Angew. Chem. Int. Ed. 2006, 45, 6104.
[3] a) Y. Zhao, X. Zhao, J. Hu, M. Xu, W. Zhao, L. Sun, C. Zhu, H. Xu, Z. Gu, Adv. Mater. 2009, 21, 569; b) L. Rodriguez-Lorenzo, L. Fabris, R. A. Alvarez-Puebla, Anal. Chim. Acta 2012, 745, 10; c) F. Zheng, Y. Cheng, J. Wang, J. Lu, B. Zhang, Y. Zhao, Z. Gu, Adv. Mater. 2014, n/a.
[4] G. Shtengel, J. A. Galbraith, C. G. Galbraith, J. Lippincott-Schwartz, J. M. Gillette, S. Manley, R. Sougrat, C. M. Waterman, P. Kanchanawong, M. W. Davidson, R. D. Fetter, H. F. Hess, Proc. Nat. Acad. Sci. USA 2009, 106, 3125.
[5] a) K. Braeckmans, S. C. De Smedt, M. Leblans, R. Pauwels, J. Demeester, Nat. Rev. Drug. Discov. 2002, 1, 447; b) K. Braeckmans, S. C. De Smedt, Nat. Mater. 2010, 9, 697; c) K. Braeckmans, S. C. De Smedt, C. Roelant, M. Leblans, R. Pauwels, J. Demeester, Nat. Mater. 2003, 2, 169; d) K. D. Bake, D. R. Walt, Ann. Rev. Anal. Chem. 2008, 1, 515; e) W. E. Doering, M. E. Piotti, M. J. Natan, R. G. Freeman, Adv. Mater. 2007, 19, 3100; f) R. G. Freeman, P. A. Raju, S. M. Norton, I. D. Walton, P. C. Smith, L. He, M. J. Natan, M. Y. Sha, S. G. Penn, Method Mol. Biol. 2005, 303, 73; g) S. R. Nicewamer-Pena, R. G. Freeman, B. D. Reiss, L. He, D. J. Pena, I. D. Walton, R. Cromer, C. D. Keating, M. J. Natan, Science 2001, 294, 137; h) M. Y. Sha, I. D. Walton, S. M. Norton, M. Taylor, M. Yamanaka, M. J. Natan, C. Xu, S. Drmanac, S. Huang, A. Borcherding, R. Drmanac, S. G. Penn, Anal. Bioanal. Chem. 2006, 384, 658.
[6] a) F. Cunin, T. A. Schmedake, J. R. Link, Y. Y. Li, J. Koh, S. N. Bhatia, M. J. Sailor, Nat Mater 2002, 1, 39; b) N. H. Finkel, X. Lou, C. Wang, L. He, Anal. Chem. 2004, 76, 352 A; c) D. C. Pregibon, M. Toner, P. S. Doyle, Science 2007, 315, 1393.
[7] A. R. Vaino, K. D. Janda, Proc. Nat. Acad. Sci. USA 2000, 97, 7692.
[8] H. Fenniri, L. Ding, A. E. Ribbe, Y. Zyrianov, J. Am. Chem. Soc. 2001, 123, 8151.
[9] a) M. Bruchez, M. Moronne, P. Gin, S. Weiss, A. P. Alivisatos, Science 1998, 281, 2013; b) J. Raez, D. R. Blais, Y. Zhang, R. A. Alvarez-Puebla, J. P. Bravo-Vasquez, J. P. Pezacki, H. Fenniri, Langmuir 2007, 23, 6482; c) J. Lee, P. W. Bisso, R. L. Srinivas, J. J. Kim, A. J. Swiston, P. S. Doyle, Nat. Mater. 2014, 13, 524.
[10] M. Sanles-Sobrido, W. Exner, L. Rodriguez-Lorenzo, B. Rodriguez-Gonzalez, M. A. Correa-Duarte, R. A. Alvarez-Puebla, L. M. Liz-Marzan, J. Am. Chem. Soc. 2009, 131, 2699.
[11] G. Goddard, L. O. Brown, R. Habbersett, C. I. Brady, J. C. Martin, S. W. Graves, J. P. Freyer, S. K. Doorm, J. Am. Chem. Soc. 2010, 132, 6081.
[12] a) M. Howarth, W. Liu, S. Puthenveetil, Y. Zheng, L. F. Marshall, M. M. Schmidt, K. D. Wittrup, M. G. Bawendi, A. Y. Ting, Nat. Meth. 2008, 5, 397; b) X. Qian, X.-H. Peng, D. O. Ansari, Q. Yin-Goen, G. Z. Chen, D. M. Shin, L. Yang, A. N. Young, M. D. Wang, S. Nie, Nat Biotech 2008, 26, 83; c) A. Serge, N. Bertaux, H. Rigneault, D. Marguet, Nat. Meth. 2008, 5, 687.
[13] P. Rivera_Gil, C. Vazquez-Vazquez, V. Giannini, M. P. Callao, W. J. Parak, M. A. Correa-Duarte, R. A. Alvarez-Puebla, Angew. Chem. Int. Ed. 2013, 52, 13694.

1. An analysis device (100) for identification of analytes in fluids comprising:
a casing (101) enclosing at least partially a sample region for receiving a fluid sample, and a nanoparticle region for storing at least a nanoparticle fluid;
the sample region and the nanoparticle region being in fluid communication each other through at least a passage (3);
driving means in fluid communication with the passage (3);
a mixing region (31) in fluid communication with the passage (3), the mixing region (31) being configured to receive a combination defined by a mixture of the fluid sample and the nanoparticle fluid; and
the casing (101) being adapted to allow at least an incident monochromatic light from an external source to strike on the mixing region (31) so that the combination is excitable, and at least a reflected light from the mixing region (31) to leave the casing (101).

2. The analysis device (100) according to claim 1, wherein the sample region comprises at least a sample container (91).

3. The analysis device (100) according to claim 1, wherein the nanoparticle region comprises at least a nanoparticle container (92).

4. The analysis device (100) according to claim 1, wherein the driving means is of passive type or active type.

5. The analysis device (100) according to claim 4, wherein the driving means of the passive type comprises the passage (3) configured to allow capillary motion.

6. The analysis device (100) according to claim 4, wherein the driving means of the active type comprises a pump (6).

7. The analysis device (100) according to claim 6, wherein the casing (101) is provided with at least one contacting element (11) for electrically feeding the driving means and/or transmitting data.

8. The analysis device (100) according to claim 1, wherein the casing (101) comprises a first light permeable portion (17) to allow the incident monochromatic light to strike on the mixing region (31) and a second light permeable portion (22) to allow the reflected light to leave the casing (101).

9. The analysis device (100) according to claim 1, wherein the analysis device comprises a membrane (8) in fluid communication with the sample region such that the sample region can be fed from outside the casing (101).

10. The analysis device (100) according to claim 1, wherein the fluid sample comprises at least one target analyte.

11. The analysis device (100) according to claim 1, wherein the nanoparticle fluid comprises a plurality of SERS-encoded nanoparticles.

12. The analysis device (100) according to claim 1, wherein the incident monochromatic light is a lasser beam.

13. The analysis device (100) according to claim 1, wherein the analysis device (100) has a capsule-shape configuration.

14. An analysis apparatus (200) for identification of analytes in fluids comprising:
a receiving region (201) for receiving an analysis device (100) according to claim 1;
an emitter (202) adapted to produce an incident monochromatic light to strike on the mixing region (31);
reading means (203) configured to receive the reflected light from the mixing region (31) and to reading a SERS signal or an increase in said signal; and
control means (204) in data communication with the emitter (202) and the reading means (203).

15. The analysis apparatus (200) according to claim 14, wherein the emitter (202) is a lasser emitter.

16. The analysis apparatus (200) according to claim 14, further comprising a connecting port (205) able to be associated with at least one contacting element (11).

17. The analysis apparatus (200) according to claim 14, wherein the receiving region comprises fixing means (206) matching at least partially the casing (101).

18. The use of an analysis device (100) according to claim 1 for the identification of analytes in fluids applying the SERS effect.
